(19) United States
(12) Patent Application Publication
(10) Pub. No.: US 2013/0002241 A1
(43) Pub. Date: Jan. 3, 2013

(54) ENERGY SELF-SUFFICIENT APPARATUS AND METHOD FOR POSITION DETECTION

(75) Inventors: Holger Alfons Eggert, Grafelfing (DE); Sven Klausnitzer, Unterhaching (DE)

(73) Assignee: EnOcean Gmbh

(21) Appl. No.: 13/404,432

(22) Filed: Feb. 24, 2012

(30) Foreign Application Priority Data
Feb. 24, 2011 (DE) 10 2011 012 296.6

(51) Int. Cl. G01B 7/14; H01F 7/02

(52) U.S. Cl. 324/207.11; 335/219

(57) ABSTRACT

Energy self-sufficient apparatus with an energy converter, which comprises at least one permanent magnetic element, a second permanent magnetic element and a coil, wherein at least one of the permanent magnetic elements is arranged such that its magnetic field penetrates a coil and the second permanent magnetic element is arranged movable such that the magnetic field penetrating the coil can be changed by means of the movement.

The invention relates to an energy self-sufficient apparatus with an electromagnetic energy converter as well as a method for position detection pursuant to the coordinated Claims.

To monitor the actual position and/or the setting of a movable apparatus relative to a reference position, such as a door, a gate, or a window, previously known systems use radio sensors that are supplied by a solar cell, for example, which are supplied with the necessary energy from a solar cell or from a battery. This correspondingly requires a minimum luminosity for reliable operation, and such system is unsuitable for use in darkrooms.

Battery-operated systems have the inherent disadvantage that they operate only for as long as the battery can provide the minimum voltage for the measuring apparatus and therefore require maintenance, i.e. regular battery replacement.

The object of the present invention is to indicate an energy converter and a method for position finding which can at least prevent the previously listed disadvantages and make it possible to detect a position reliably.

This problem is solved among other things by the energy converter with the features of claim 1 and a method for position detection pursuant to claim 7.

Advantageous refinements of the energy converter and the method for position detection are the subject of the dependent Claims.

Because of the fact that an energy converter is provided in the energy self-sufficient apparatus, which comprises a first permanent magnetic element, a second permanent magnetic element and a coil, wherein at least one of the permanent magnetic elements is arranged such that its magnetic field penetrates the coil and the second permanent magnetic element can be moved such that by means of the movement the magnetic field that penetrates the coil can be changed, this provides both electrical energy for the position detection as well as also for the transmission of the radio pulse.

In a refinement, the energy converter comprises additional ferromagnetic elements for the control and concentration of at least one of the magnetic fields, as a result of which the efficiency can be improved.

The second permanent magnetic element is made up from multiple individual permanent magnetic elements, which are interconnected, wherein the connection can occur by means of a ferromagnetic adapter.

In a refinement, the energy self-sufficient apparatus additionally comprises a radio transmitter, which is suitable to be operated by voltage pulses generated in the energy converter, and to send out a telegram after the activation.

If the transmitter is designed such that the type of the telegram sent out depends upon the polarity of the voltage pulses generated in the energy converter, then it is possible to detect a direction of motion with high-efficiency, for example, and transmit the result.

If the energy self-sufficient apparatus comprises at least one additional sensor, which is operated by the voltage pulse generated in the energy converter, then its measured values can likewise be transmitted in the telegram sent out by the radio transmitter.

With such device it is possible to perform a method for position detection, which in one embodiment is characterized in that the first permanent magnetic element and the second permanent magnetic element are reciprocally moved such that a voltage pulse is induced by the movement of the second permanent magnetic element.

If the energy converter furthermore has a radio transmitter, then this can be operated with the induced voltage pulse. After the radio transmitter has been activated by the voltage pulse, a telegram is sent out.

In this context, it is advantageous if the type of the telegram is dependent upon the polarity of the voltage pulse, so that the position of the monitored apparatus and/or the monitored object can be determined.

In a particularly advantageous embodiment of the method as taught by the invention, the induced voltage pulse provides electrical energy to at least one additional sensor, wherein at least one measured value of the at least one sensor is likewise sent out by the telegram of the radio transmitter.

Such device can be used for detecting the position of doors, gates, windows, for example, and generally for all movable objects and apparatuses. Such device is therefore also suitable for use in building automation.

Moreover it is also conceivable to use such device as an anti-theft device on objects or for monitoring the position of articles. The monitoring of motion, such as during conveying or to monitor a production sequence, is also conceivable.

The device and the method as taught by the invention therefore make it possible to perform non-contact position detection of mobile apparatuses and/or articles. They likewise render it possible to supply electrical current to sensors or transmitters, for example, without making contact. Such device is therefore suitable for the secure position detection of mobile apparatuses/articles and/or the safe supply of electrical current to detection systems, because it requires no maintenance and can moreover be utilized in all locations, since it is independent of external conditions and ensures a reliable energy supply. In the following, embodiments of the device as taught by the invention and the method as taught by the invention are explained by means of the Figures.

In this context, identical elements and/or those which have the same effect have the same reference symbols, as follows:

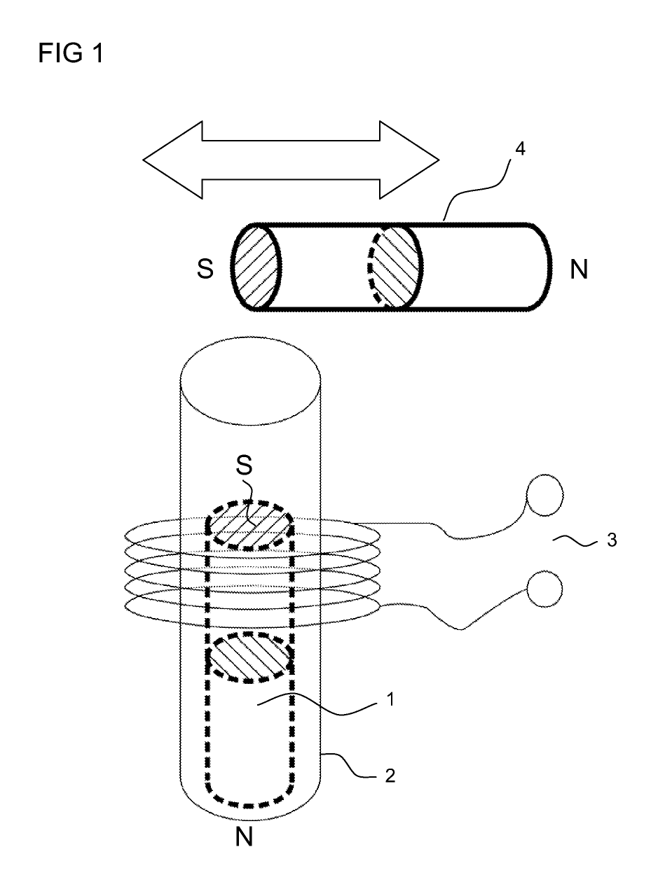

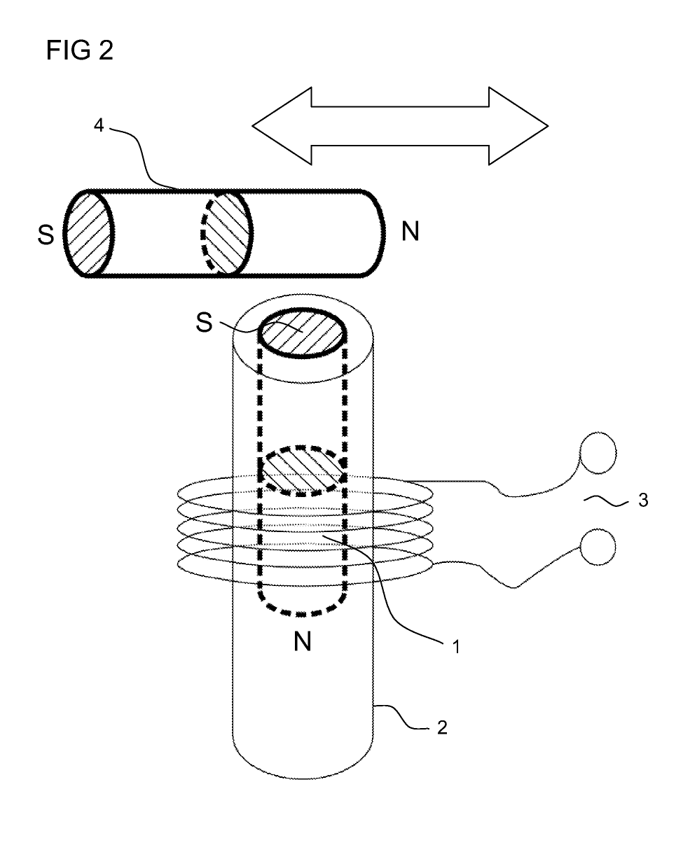

FIGS. 1 and 2 illustrate a diagrammatic embodiment of the method as taught by the invention,

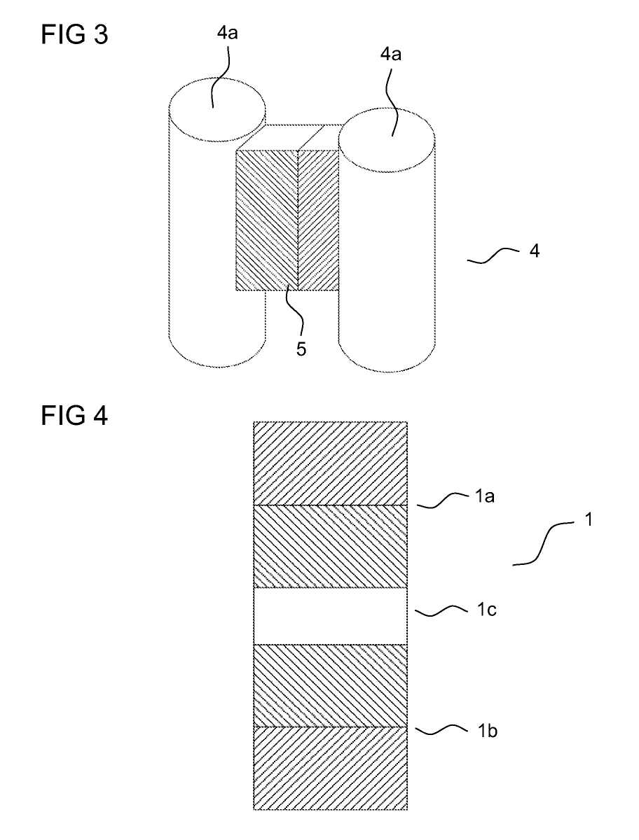

FIG. 3 illustrates a diagrammatic embodiment of an advantageous refinement of a first permanent magnetic element of the device as taught by the invention,

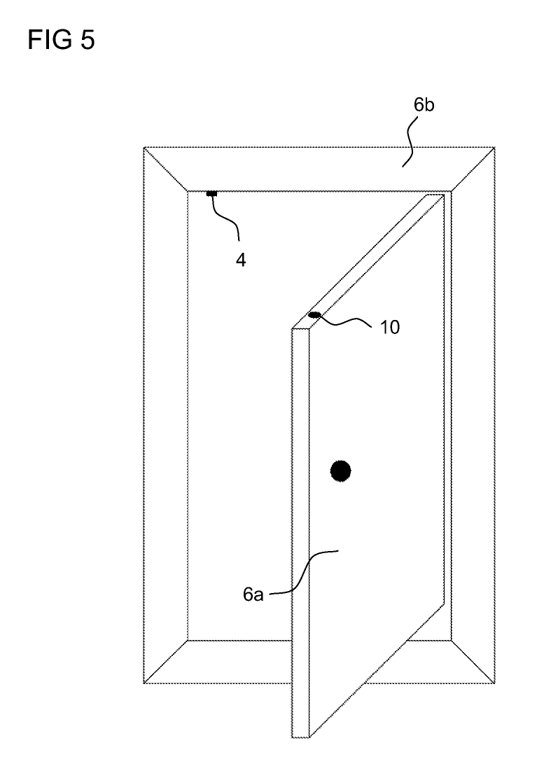

FIG. 4 illustrates a diagrammatic embodiment of an advantageous refinement of a second permanent magnetic element of the device as taught by the invention, and

FIGS. 5 to 7 illustrate a diagrammatic embodiment of the device as taught by the invention and the method as taught by the invention for the detection of a door position.

FIG. 1 illustrates a first status of an embodiment of the energy converter utilized. A first permanent magnetic element (4) and a second permanent magnetic element (1) are arranged reciprocally movable. The reciprocal mobility is indicated by the arrow above the first permanent magnetic element (4), which illustrates that the first permanent magnetic element (4) can only move along the horizontal from left to right and vice versa.

The second permanent magnetic element (1) is located in a sleeve (2) in which it can move up and down. A coil (3) is fitted around the sleeve (2), through which the second permanent magnetic element (1) can move. It is advantageous if the sleeve is slippery, in particular self-lubricating and is formed from Teflon, for example.

The magnetic North Pole (N) of the second permanent magnetic element (1) is formed on the bottom half of the second permanent magnetic element (1) which is in the shape of a cylinder, for example, as shown in FIG. 1, while the magnetic South Pole (S) is formed on the top half.

The magnetic South Pole (S) of the first permanent magnetic element (4) is extending along the left half of the for example cylindrical shaped first permanent magnetic element (4) and the magnetic North Pole (N) along the right half.

In a first position, as indicated in FIG. 1, the magnetic South Pole (S) of the first permanent magnetic element (4) is perpendicular above the magnetic South Pole (S) of the second permanent magnetic element (1). Due to the magnetic repulsion between magnetic elements of the same polarity, the second permanent magnetic element (1) moves away from the first permanent magnetic element (4) to the maximum extent, i.e. the second permanent magnetic element moves down within the sleeve until it impinges on the lower boundary of the sleeve.

During this first position, the coil (3) surrounds the magnetic South Pole (S) of the second permanent magnetic element (1) at all times.

If the first permanent magnetic element (4) is now moved further left along the horizontal, as indicated in FIG. 2, the magnetic South Pole (S) of the first permanent magnetic element (1) is now no longer perpendicular above the second permanent magnetic element (1), but the magnetic North Pole (N) of the first permanent magnetic element (4). Therefore, permanent magnetic elements with opposite polarity are opposite each other.

Because of the regularities of magnetism, magnetic elements with opposite polarity attract each other, i.e. the second permanent magnetic element (1) now moves within the sleeve (2) towards the first permanent magnetic element (4) until it reaches the upper boundary of the sleeve (2). For this purpose, the sleeve (2) is designed such that it has at least 1.5 times the length of the second permanent magnetic element (1). This ensures that the coil (3), after movement of the second permanent magnetic element (1) from a lower position to an upper position or vice versa, in each case surrounds the other pole of the second permanent magnetic element (1).

The fact that the coil (3) surrounds a first magnetic pole of the second permanent magnetic element (1) generates a first magnetic flux through the surface surrounded by the coil (3). The transition of a first magnetic pole to the opposite pole changes the magnetic flux through the surface surrounded by the coil (3). Pursuant to Faraday's law of induction, a change of the magnetic flux through the surface which surrounds a coil is linked to the induction of a voltage pulse.

Depending on the direction of motion of the second permanent magnetic element (1), voltage pulses with opposite polarity are respectively created in the coil (3). These can be used for the detection of the position of mobile apparatuses and articles as described in the following refinements. The device as well as the method described in FIGS. 1 and 2 are therefore suitable for converting magnetic field energy into electrical energy. As described later with reference to FIGS. 5 to 7, the device is suited for monitoring the position of mobile apparatuses and/or articles.

FIG. 3 illustrates a refinement of a first permanent magnetic element (4), which consists of a permanent magnet (4a) and ferromagnetic elements (5) attached thereto. For this purpose, the elements (5) attached on the permanent magnet (4a) respectively adopt the magnetic polarity of the one pole of the permanent magnet (4a), onto which they are respectively attached (the magnetic polarity is indicated by corresponding crosshatching of the surface). It is therefore possible to adapt and/or adjust the form of the magnetic field and the local intensity/density of the magnetic lines of force.

FIG. 4 illustrates an advantageous embodiment of a second permanent magnetic element (1), wherein the element is made up of several permanent magnetic elements (1a) and (1b), which are connected by means of a ferromagnetic adapter (1c). By means of the ferromagnetic adapter (1c), the permanent magnetic elements (1a) and (1b) can be connected expediently and easily, in spite of the same magnetic polarity of the interconnecting points, since because of the ferromagnetic adapter (1c) they are neither reciprocally attracted nor repulsed.

With such type of design, when viewed from the top towards the bottom, a magnet change results from North Pole to South Pole and subsequently inversely from the South Pole to North Pole. During a movement of a second permanent magnetic element (1) of such design from a bottom position, as illustrated in FIG. 1, to a top position, as illustrated in FIG. 2, a twofold change of the magnetic flux results in the surface surrounded by the coil (3) and consequently two opposite voltage pulses are induced successively in the coil (3), which can be used for supplying energy to a radio transmitter or to additional sensors, for example.

Second permanent magnetic elements (1) are also conceivable which provide a multiplicity of such arrangements of permanent magnetic elements (1a) and (1b), so as to increase the number of changes of the magnetic polarity along the second permanent magnetic element (1).

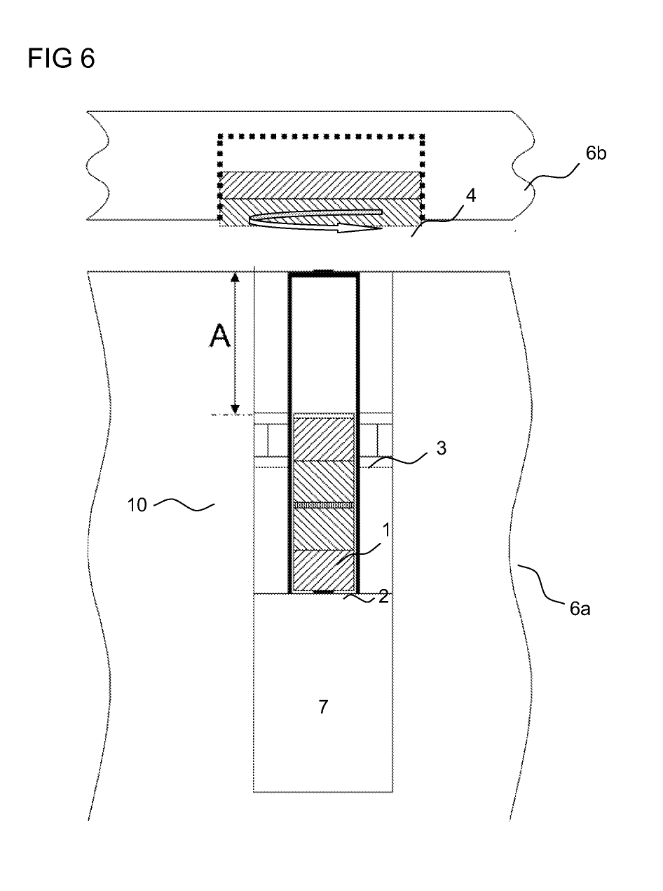

FIGS. 5 and 6 show an actual application of the method as taught by the invention, which is the monitoring of the opening status of a door.

FIG. 5 illustrates the spatial configuration of the individual components. The first permanent magnetic element (4) is located in the doorframe (6b), while the remaining part of the device (10) is located inside the door leaf (6a). So that also minor changes of the door position can be detected, it is advantageous if the components are arranged as far as possible away from the rotation axis of the door leaf (6a).

In the actual embodiment, the components are therefore arranged as far as possible to the left in order to get the maximum distance to the rotation axis which is arranged on the right.

FIG. 6 illustrates a magnified diagrammatic representation of the device for monitoring the opening status of a door.

A first permanent magnetic element (4) is located in the doorframe (6b), wherein the first permanent magnetic element (4) is arranged such that its distance to the door (6a) and therefore also to the remaining part of the device (10) can be adjusted. For this purpose, the doorframe (6b) as well as the first permanent magnetic element (4) can be provided with a thread, so that the distance can be adapted thereby by means of screwing the element (4) either up or down in the thread of the doorframe (6b).

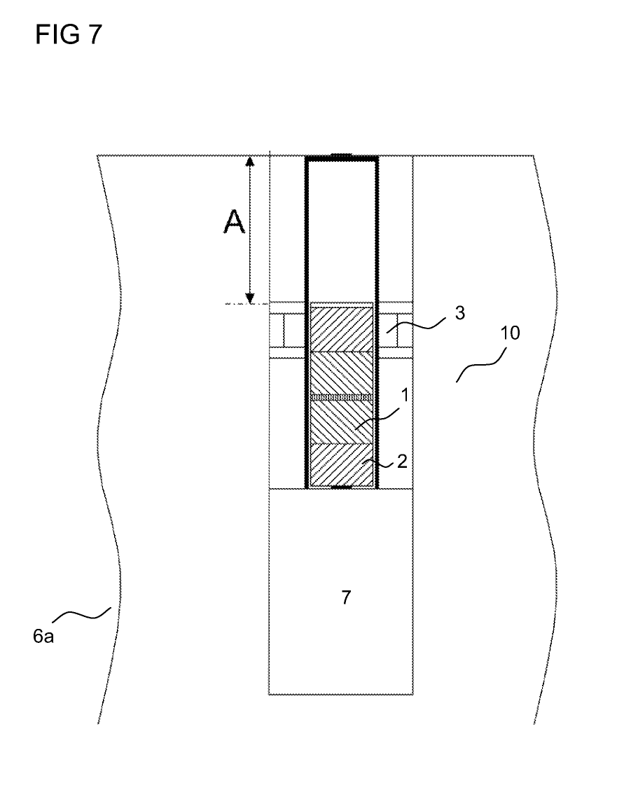

The remaining part of the device (10), which is illustrated in FIG. 7 in detail, is arranged in the door leaf (6a). A sleeve (2) is surrounded by a coil (3). A second permanent magnetic element (1) is arranged inside the sleeve (2), which is designed as described in FIG. 4. Further space (7) can be carved out below the sleeve (2) in the door leaf (6a) for the provision of additional electronic components such as sensors or radio transmitters.

Because of gravity, the second permanent magnetic element (1) is located in a bottom position within the sleeve (2) and the coil (3) surrounds a first magnetic pole of the second permanent magnetic element (1).

The second permanent magnetic element (1) can be lifted by a lift distance (A), so that two voltage pulses are generated by the coil (3), the upper end of the permanent magnetic element (1) impinges against the upper boundary of the sleeve (2) and the lower end of the second permanent magnetic element (1) is surrounded by the coil (3) and this therefore again surrounds a first magnetic pole of the second permanent magnetic element (1).

If the opened door is now closed, i.e. the door leaf (6a) is moved towards the door frame (6b), then the remaining device (10) is moved below the permanent magnetic element (4). If the first permanent magnetic element (4) is designed as a single permanent magnet, as shown in FIG. 5, where its pole facing the door leaf has opposite magnetic polarity to the other uppermost pole of the second permanent magnetic element (1), then these poles increasingly attract each other as the distance between the door leaf (6a) and the doorframe (6b) decreases.

As soon as the weight, as well as also the static friction and dynamic friction on the walls of the sleeve (2) will be overcome by the attractive force of the poles, the second permanent magnetic element (2) starts to move from the first, lower position towards a second, upper position. The closer the door leaf (6a) and the doorframe (6b) come together, all the stronger the attraction force and all the faster the second permanent magnetic element moves into the direction of the second, upper position.

By the movement from the first, lower position to the second, upper position of the second permanent magnetic element (1), two voltage pulses are induced by changes in flux in the surface surrounded by the coil (3), which can be supplied to an electrical consumer, such as to a sensor or a radio transmitter arranged below the sleeve in the door. To detect the opening status, it is even sufficient if an additional transmitter is attached, which depending upon the polarity, sends out a corresponding telegram.

If the door is opened again, i.e. the door leaf (6a) is moved away from the door frame (6b), then the attractive force of the different magnetic poles decreases with increasing distance and the second permanent magnetic element (1) is moved by the weight from the second, top position back into the first, lower position. In this context, by changes of the magnetic flux through the surface surrounded by the coil (3), voltage pulses are again created by the coil (3), which can be utilized for the detection of the opening status.

In a refinement of the first permanent magnetic element (4), both magnetic poles of the element (4) are facing the door leaf (6a). As shown in FIG. 3, a permanent magnetic element (4) could be used, for example. For this purpose, the element (4) is arranged such that the one magnetic pole which has the same magnetic polarity as the uppermost pole of the second permanent magnetic element (1), is first passed by the second permanent magnetic element (1) during the closing of the door. This has the advantage that the second permanent magnetic element still remains in a first, lower position when it approaches the first permanent magnetic element (4), due to the repulsion of poles having the same polarity, and only moves suddenly into a second, top position, if it is directly below the opposite magnetic pole of the first permanent magnetic element (4).

The consequence is that the change of the magnetic flux in the surface that is surrounded by the coil (3) occurs very much faster and because, pursuant to Faraday's law of induction, a higher voltage pulse is induced, and more electrical energy is therefore available.

Here too, a sudden movement of the second permanent magnetic element (1) occurs again when the door is opened, as a result of which a high voltage pulse for detecting the opening status is available again.

It must be noted that the positioning of the first permanent magnetic element (4) in the doorframe (6b) and the positioning of the remaining part of the device in the door leaf (6a) are interchangeable.

In some refinements it is possible with the devices described herein to generate electrical energy for every application in the amount of at least I.0*10̂−5 joule, I.0*10̂−4 joule, I.0*10̂−3 joule, or higher. In different refinements it is possible to generate electrical energy in the amount of approximately I.0*10̂−5 joule to approximately 5.0*10̂−3 joule with the device described herein.

In some refinements, mechanical energy is converted into electrical energy with a degree of utilization of at least 1%, 5%, 10%, or more. In some refinements, mechanical energy is converted into electrical energy with a degree of utilization in the range of 1%-10%.

In the same way, such device can also be fitted in the door leaves horizontally, for example.

The embodiments above are described by means of position finding of a door leaf or of a door wing. It is obvious however, that applications for any type of mobile closures of openings on and in buildings and vehicles, but even in the outdoor sector, such as cattle gates, traps, barriers, lock gates, are conceivable.

1. An energy self-sufficient apparatus with an energy converter, which comprises at least one permanent magnetic element, a second permanent magnetic element and a coil, wherein at least one of the permanent magnetic elements is arranged such that its magnetic field penetrates the coil and the second permanent magnetic element is arranged mobile such that the magnetic field penetrating the coil can be changed by means of the movement.

2. The energy self-sufficient apparatus according to claim 1, wherein additional ferromagnetic elements are provided for controlling at least one of the magnetic fields.

3. The energy self-sufficient apparatus according to claim 1, characterized in that the second permanent magnetic element consists of multiple individual permanent magnetic elements.

4. The energy self-sufficient apparatus pursuant to claim 1, characterized in that the energy converter is connected with a radio transmitter.

5. The energy self-sufficient apparatus according to claim 1, characterized in that the arrangement comprises at least one additional sensor.

6. The energy self-sufficient apparatus according to claim 5, characterized in that at least one sensor is a position sensor.

7. A method for position detection with an energy self-sufficient apparatus pursuant to claim 1, wherein the first permanent magnetic element (4) and the second permanent magnetic element (1) are reciprocally moved such that a voltage pulse in the coil (3) is generated by the movement of the second permanent magnetic element (1).

8. The method according to claim 7, wherein the voltage pulse supplies energy to the radio transmitter, and wherein the radio transmitter sends out a telegram subsequent to an activation.

9. The method according to claim 8, characterized in that the polarity of the voltage pulse generated is utilized for determining the position.

10. The method according to claim 8, characterized in that the voltage pulse generated supplies electrical energy to at least one sensor and that at least one measured value of the at least one sensor is sent out by the radio transmitter together with the telegram.
